(19) United States
(12) Patent Application Publication
(10) Pub. No.: US 2002/0181099 A1
(43) Pub. Date: Dec. 5, 2002

(54) Rear projection screen without ghost image artifacts

(76) Inventors: Hoang-Yan Lin, Keelung (TW); Pong Lai, Taipei (TW); Wann-Diing Tyan, Chia-I (TW)

Correspondence Address: BIRCH STEWART KOLASCH & BIRCH, PO BOX 747, FALLS CHURCH, VA, 22040-0747, US

(21) Appl. No.: 10/014,514

(22) Filed: Dec. 14, 2001

(30) Foreign Application Priority Data
May 31, 2001 (TW) 90113124

(51) Int. Cl. G03B 21/60

(52) U.S. Cl. 359/457

(57) ABSTRACT

A rear projection screen without ghost image artifacts, which can reflect light containing images to a display screen and effectively eliminate ghost image artifacts. The invention includes a reflective mirror, a field lens, a diffusive plate, and a diffuser located at the field lens facing the reflective mirror. Through the diffusion effect of the diffuser and minimizing the thickness of the field lens, ghost image artifacts can be effectively reduced.

### BACKGROUND OF THE INVENTION

1. Field of Invention

The invention relates to a rear projection screen used in rear projection display systems. More particular, it relates to a rear projection screen without ghost image artifacts.

2. Related Art

The rear projection screen is the key element in determining the quality of final images in rear projection display systems, such as a rear projection monitor or a rear projection TV. As shown in FIG. 1, the two-plate rear projection screen has been widely applied to rear projection display systems. One of the two plates is simply a diffusive plate 30 or a diffusive plate 30 with a lenticular lens. Its main function is to adjust the view angle and the gain. The other plate is the field lens, which can be a Fresnel lens 20. Its main function is to converge the projective beams to control the uniformity of the projection screen. With an additional reflective mirror 10 (such as a folding mirror, which will serve as an example hereinafter), beams from a light source 70 are reflected toward the Fresnel lens 20.

Beams from the light source 70 are reflected by the reflective mirror 10 and then projected outward by the Fresnel lens 20 to form an image 71. However, the Fresnel lens 20 is not a perfect lens after all, thus resulting in defects in projected images. These defects are called the ghost image artifacts. The causes of forming the ghost image artifacts include:

1. The first type ghost image artifact 72 results from multiple internal reflections between two surfaces of the Fresnel lens 20. One will see multiple ghost images by the main image (i.e. the projection image 71). This type of ghost images is more serious when the focal length of the Fresnel lens 20 becomes shorter. These ghost images can be discovered if one looks closely at a rear projection screen, particularly when a pattern generator is used to produce a specific pattern.

2. The second type ghost image artifact 73 results from the reflection between the back surfaces (i.e. the surface that receives reflected beams from the reflective mirror 10) of the Fresnel lens 20 and the reflective mirror 10. It often has displaced and slant ghost images, which are usually images located in the upper portion of the display screen.

3. The third type ghost image artifact 74 results from the reflection between the front surface 21 (or active lens) of the Fresnel lens 20 and the reflective mirror 10. Due to the reflection from the front surface 21 of the Fresnel lens 20, the ghost images are distorted and usually located in the lower portion of the display screen. The second type ghost images 73 and the third type ghost images 74 are more obvious in a compact rear projection monitor, and are not easy to be discovered in a rear projection TV.

Wang, Y.-F., Masuda, M., Nishiguchi, T., and Akiyama, H. have a detailed discussion on the first type ghost images 72 in the paper “Optimizing the cutting processes of mold Dies to improve the optical characteristics of Fresnel screens” (JSME International Journal, series C, Vol. 41, pp. 938-946, 1998). To maintain the alignment function of the front surface 21 (active surface) of the Fresnel lens 20, the non-lens surface 22 (or passive surface) of the Fresnel lens 20 has to be coarsened. With reference to FIG. 2, the coarsening is done to the mold 27 of the Fresnel lens 20. (For example, one can cut the non-lens surface 22 into a frosted surface 23 using knifes.) Since such machining is done to the mold 27, a high accuracy is required and the cost is higher too. Some people suggest that the blackening process be performed on the non-lens surface 22 (passive surface), as shown in FIG. 3. However, this method has some difficulty in practice. If the back surface of the Fresnel lens 20 is made as an anti-reflection surface (not shown), all the above-mentioned types of ghost images in principle can be reduced. Nevertheless, making anti-reflection surfaces is not only expensive but also technically difficult for large area display screens.

Of course, there are some other methods that sacrifice certain features of the Fresnel lens. For example, using a Fresnel lens 20 with a longer focal length can reduce the first type ghost images 72 (FIG. 4). The projection image 71′ is displaced upwards and the first type ghost image 72 is shifted toward the projection images 71′, thus reducing the first type ghost images. Nonetheless, the homogeneity of the screen is worse. From geometrical optics simulation, one can see that the above-mentioned ghost images cannot be eliminated by refining the design of the Fresnel lens 20 or changing the relative positions of the display screen and the reflective lens 10. Therefore, the conventional solution is either too expensive or impractical.

### SUMMARY OF THE INVENTION

For solving the foregoing problems, the invention provides a rear projection screen without ghost image artifact that can properly eliminate or reduce ghost images and can be readily implemented without deteriorating the screen characters too much.

In accordance with the disclosed rear projection screen without ghost image artifact, beams containing images are reflected by a reflective mirror and projected onto a display screen. It contains a field lens, a diffusive plate and a diffuser. The field lens is on the reflected optical path of the reflective mirror to receive the beams reflected from the reflective mirror, converge the beams, and let them go out from an outing surface. The diffusive plate is on the optical path of the outgoing beams from the field lens to display the image contained therein and to adjust the view angle and the gain of the light source. The diffuser is attached on the field lens on the side of the reflective mirror. The diffuser can diffuse the beams reflected between the diffuser and the reflective mirror and the beams multiply reflected inside the field lens. By reducing the thickness of the field lens, the multiple internal reflection beams in the field lens can be overlapped with the original beam, effectively eliminating or reducing the ghost image artifact. Most important of all, the invention can be fairly easily carried out.

### BRIEF DESCRIPTION OF THE DRAWINGS

The present invention will become more fully understood from the detailed description given hereinbelow illustration only, and thus are not limitative of the present invention, and wherein:

FIG. 1 is a schematic view showing a conventional rear projection screen and the production of ghost images;

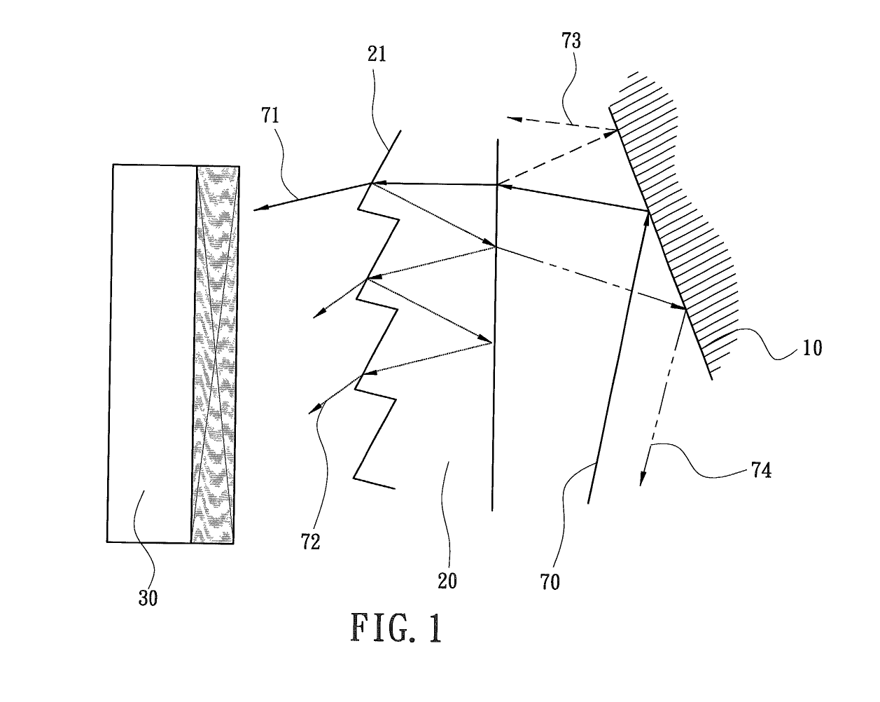

FIG. 2 is a schematic view showing the roughening of the field lens in the conventional rear projection screen;

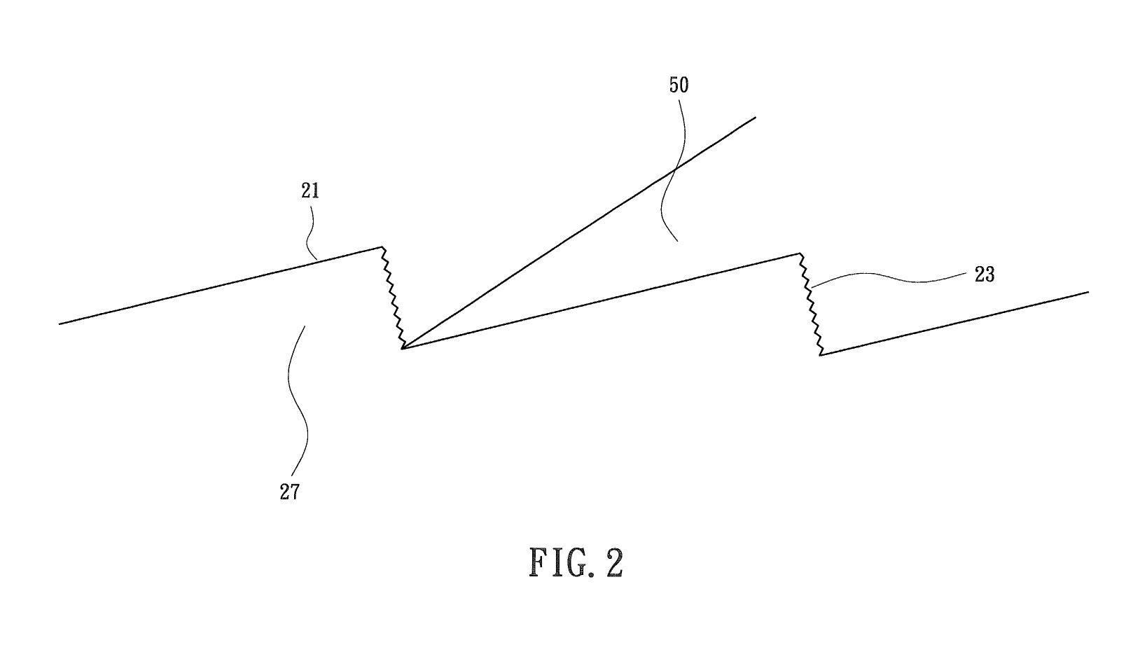

FIG. 3 is a schematic view showing the blackening of the field lens in the conventional rear projection screen;

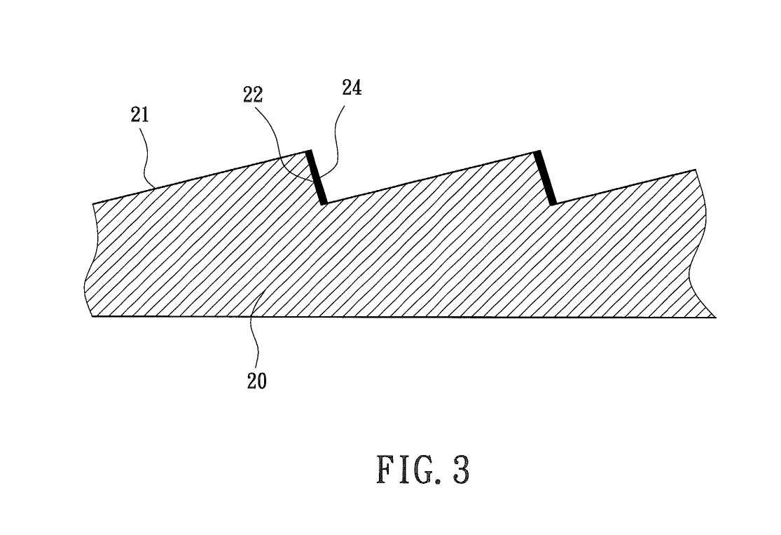

FIG. 4 is a schematic view showing the optical path when using a long focal length Fresnel lens to improve the ghost image artifact in the prior art;

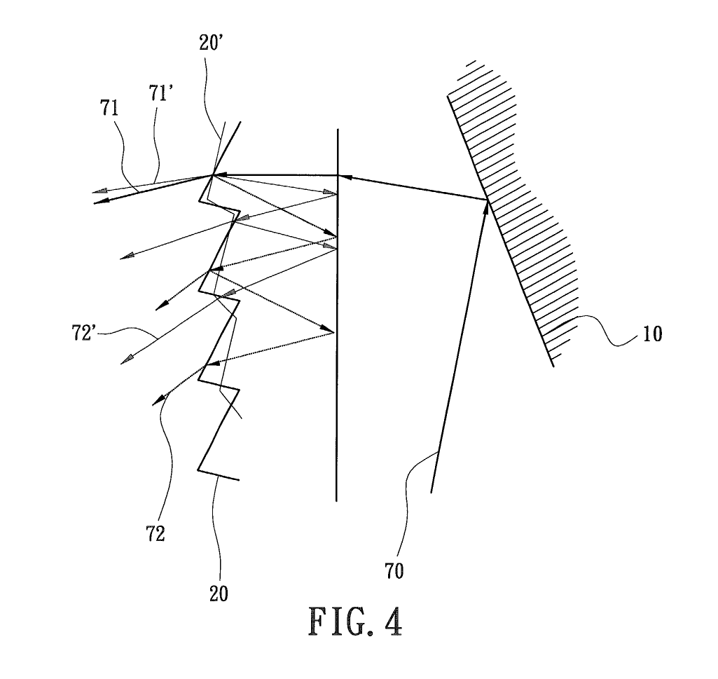

FIG. 5 is a schematic view of the optical path for a thickness reduced field lens used in the invention; and

FIG. 6 is a schematic view of the optical path for the diffuser in the invention.

In the various drawings, the same references relate to the same elements.

### DETAILED DESCRIPTION OF THE INVENTION

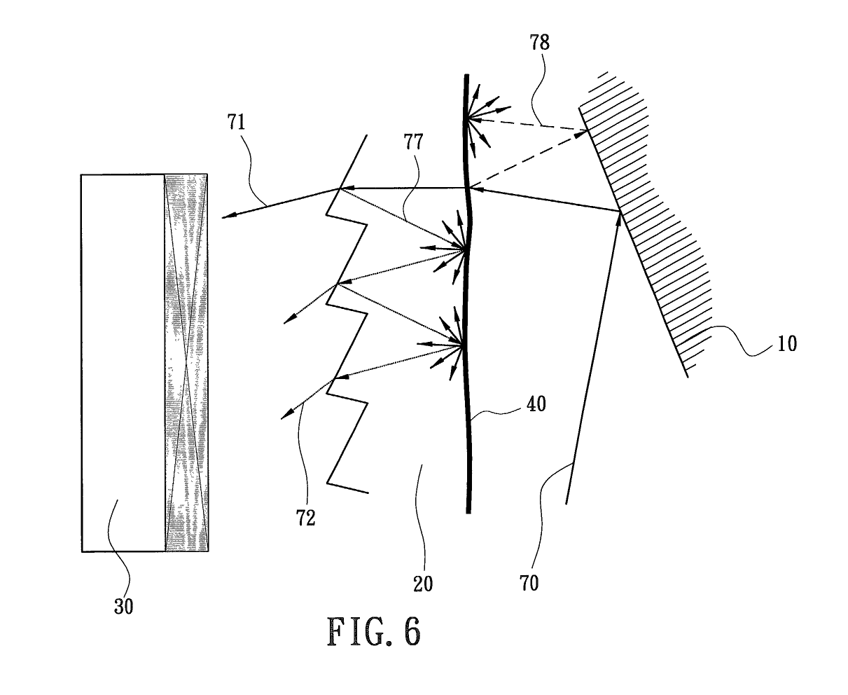

The rear projection screen without ghost images disclosed herein has a field lens (such as a Fresnel lens 20), a diffusive plate 30 (or using a diffusive plate with a lenticular lens), and a diffuser 40. As shown in FIG. 6, beams from a light source with an image is reflected by a reflective mirror 10 and projected onto a display screen. The diffuser 40 is attached on the Fresnel lens 20 on the side of the reflective mirror 10.

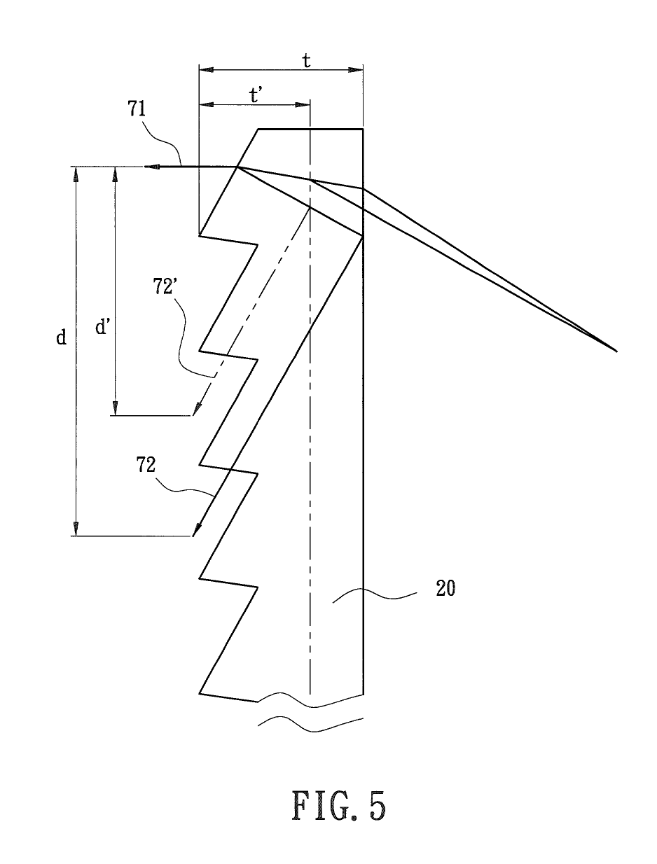

To eliminate the first type ghost images 72, one can make the thickness of the Fresnel lens 20 thinner, as demonstrated in FIG. 5. When the thickness changes from t to t′, the distance d between the projection image 71 and the first type ghost image 72 almost linearly changes to d′. When the thickness of the Fresnel lens 20 is decreased under 0.5 mm, the first type ghost image 72 almost coincides with the projection image 71 and they become indistinguishable. Thus, this method effectively eliminates the first type ghost images 72. In other words, this method eliminates the multiple ghost images due to multiple internal reflections between the front and back surfaces of the Fresnel lens 20.

On the other hand, the diffuser can eliminate the second type ghost images 73 and the third type ghost images 74. The diffuser 40 is attached on the flat surface of the Fresnel lens 20 (i.e. the incident surface from the reflective mirror 10), as shown in FIG. 6. Since the diffuser 40 can scatter beams 77 reflected from the other surface of the Fresnel lens 20 and the beams 78 reflected from the reflective mirror. This is why it can eliminate the ghost images. However, the scattering effect cannot be too strong; otherwise, the resolution of the screen will be sacrificed.

Another advantage of this method is to eliminate speckles. The diffuser 40 and the diffusive plate 30 of the screen form double scattering to eliminate speckles. This has been discussed in detail by Goldenberg, J. F., Huang Q., and Shimizu, J. A. in “Rear projection screen” (Proc. SPIE Vol. 3013, 1997).

The diffuser 40 can be a surface with expanding curves or a frosted surface. Taking the expanding curves as an example, one first record the expanding curves on a metal plate surface as the mold. Using ejection formation, pressing formation, AB gluing, or UV curing, the expanding curves on the metal plate is then copied on to different plastic materials. The scattering effect of the diffuser 40 is determined according to a certain rule. If the distance between the projection system and the screen is shorter, a diffuser 40 with a stronger scattering effect is needed. On the other hand, if the distance between the projection system and the screen is longer, a diffuser 40 with a weaker scattering effect is needed.

### EFFECTS OF THE INVENTION

By reducing the thickness of the Fresnel lens, the invention makes the first type ghost image and the projection image overlap with each other so that there is no first type ghost image. With the diffuser on the Fresnel lens on the side of the reflective mirror, beams from the multiple internal reflections inside the Fresnel lens and from the reflective mirror are scattered to reduce the second type and the third type ghost images. Along with the user of a diffusive plate, the speckle phenomena can be reduced. The invention can eliminate or reduce the ghost image artifact without deteriorating the screen properties too much. It is also very easy to be carried out.

Certain variations would be apparent to those skilled in the art, which variations are considered within the spirit and scope of the claimed invention.

What is claimed is:

1. A rear projection screen without ghost image artifact to reflect and project beams containing an image to a display screen using a reflective mirror, which comprises:
a field lens, which is located on the optical path of the reflected beam from the reflective mirror to receive and converge the reflected beams coming out of an outgoing surface;
a diffusive plate, which is located on the optical path of the outgoing beams from the field lens to display the image contained in the beams and to adjust the view angle and gain of the image; and
a diffuser, which is located on the field lens on the side of the reflective mirror to scatter the beams from the reflective mirror and the multiple internal reflection beams inside the field lens.

2. The rear projection screen of claim 1, wherein the diffusive plate is further provided with a lenticular lens.

3. The rear projection screen of claim 1, wherein the field lens is a Fresnel lens.

4. The rear projection screen of claim 3, wherein the thickness of the Fresnel lens is decreased so that the multiple internal reflection beams inside the Fresnel lens coincide with the original beams.

5. The rear projection screen of claim 4, wherein the thickness of the Fresnel lens is smaller than 0.5 mm.

6. The rear projection screen of claim 1, wherein the diffuser has a surface with expanding curves.

7. The rear projection screen of claim 6, wherein the surface with expanding curves is made by ejection formation using a mold with expanding curves.

8. The rear projection screen of claim 6, wherein the surface with expanding curves is made by pressing formation.

9. The rear projection screen of claim 6, wherein the surface with expanding curves is made by AB gluing.

10. The rear projection screen of claim 6, wherein the surface with expanding curves is made by UV curing.

11. The rear projection screen of claim 1, wherein the diffuser has a frosted surface.
